(19) United States
(12) Patent Application Publication
(10) Pub. No.: US 2022/0101699 A1
(43) Pub. Date: Mar. 31, 2022

(54) VOUCHER DISPENSING DEVICE AND VOUCHER DISPENSING METHOD

(71) Applicant: TOSHIBA TEC KABUSHIKI KAISHA, Tokyo (JP)

(72) Inventor: Akiko WATANABE, Sunto Shizuoka (JP)

(21) Appl. No.: 17/464,327

(22) Filed: Sep. 1, 2021

(30) Foreign Application Priority Data
Sep. 29, 2020 (JP) 2020-163781

(51) Int. Cl. G07F 17/42; G06Q 30/02; G06Q 20/20

(52) U.S. Cl. CPC G07F 17/42; G06Q 20/208; G06Q 30/0238; G06Q 30/0226

(57) ABSTRACT

According to an embodiment, a voucher dispensing device includes a communication interface connectable to a member points server, a member code acquiring unit configured to receive an input of a member code, and a processor. The processor is configured to acquire information regarding points associated with the member code from the member points server by sending a dummy transaction notification to the member points server via the communication interface, and then control a display unit to display the acquired information regarding the points.

### CROSS-REFERENCE TO RELATED APPLICATION

This application is based upon and claims the benefit of priority from Japanese Patent Application No. 2020-163781, filed on Sep. 29, 2020, the entire contents of which are incorporated herein by reference.

### FIELD

Embodiments described herein relate generally to an information processing device related to voucher dispensing and an information processing method related to the same.

### BACKGROUND

There is a settlement device that dispenses a voucher, such as a benefit ticket, a coupon, a cash voucher, a merchandise voucher, and the like, which is used for processing price-cuts and discounts as well as payments for commodity sales transactions and the like. With such a settlement device, the voucher is typically dispensed immediately before or after a receipt is issued. The voucher is issued/printed using the same printer that dispenses the receipt.

However, settlement devices used with a self-service type or semi-self-service type POS (point-of-sale) system or the like are operated by a customer rather than a sales clerk or the like.

This type of settlement device can be provided with a separate printer for dispensing a voucher, but the customer must take the voucher by himself/herself rather than being handed the voucher by a clerk.

As such, when a normal receipt is dispensed from the settlement device is after the checkout is completed, the customer may forget to take the voucher or may not even notice that the voucher was output by the voucher printer.

In view of these circumstances, it would be desirable to prevent the customer from forgetting to take the voucher.

### BRIEF DESCRIPTION OF THE DRAWINGS

FIG. 1 is a perspective view of a checkout system according to an embodiment.

FIG. 2 is a block diagram illustrating a checkout system according to an embodiment.

FIG. 3 is a diagram showing an example of a notification screen displayed on a touch panel of a commodity registration device.

FIG. 4 is a flowchart of commodity registration processing by a commodity registration device.

FIG. 5 is a flowchart of communication processing by a commodity registration device.

FIG. 6 is a flowchart of dispense processing by a printer.

FIG. 7 is a flowchart illustrating a procedure of communication processing by a settlement device.

### DETAILED DESCRIPTION

An object to be solved by the embodiment of the present disclosure is to provide a technique for preventing a customer from forgetting to take a voucher after checkout completion.

In general, according to an embodiment, a voucher dispensing device has communication interface connectable to a member points server, a member code acquiring unit configured to receive an input of a member code, and a processor. The processor is configured to: acquire information regarding points associated with the member code from the member points server by sending a dummy transaction notification to the member points server via the communication interface, and then control a display unit to display the acquired information regarding the points.

Hereinafter, certain example embodiments will be described with reference to the drawings. In an example embodiment, a semi-self-service POS terminal is used as one example of a settlement device. The semi-self-service POS terminal functions as a settlement device in a so-called semi-self-service type system or a semi-self-service checkout device. With such a device, or with such a system, a clerk registers the purchased commodities and then customer performs the settlement, though this may depend on the method of payment desired by the customer.

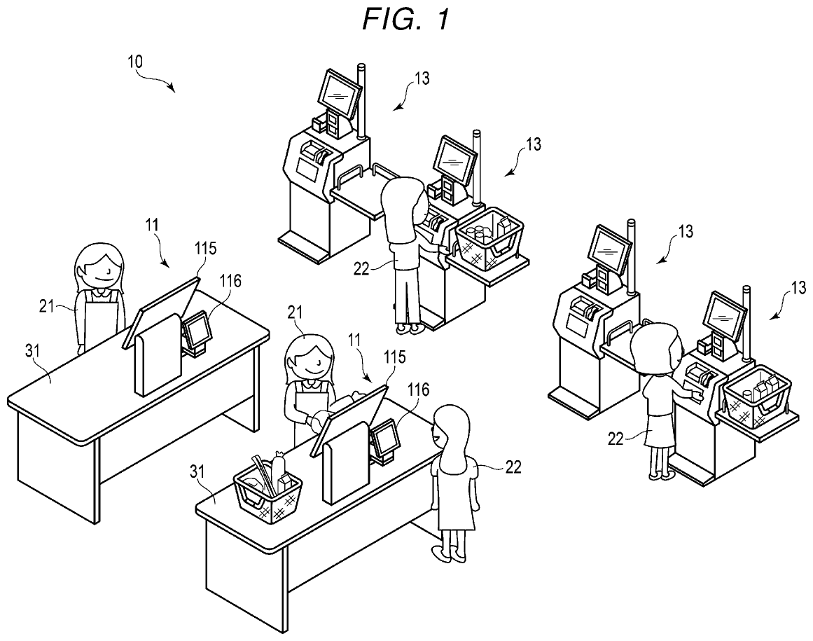

FIG. 1 is a perspective view of a checkout system 10 according to the embodiment.

The checkout system 10 includes at least one commodity registration device 11 and at least one settlement device 13. FIG. 1 shows the checkout system 10 including two commodity registration devices 11 and four settlement devices 13. The respective numbers of commodity registration devices 11 and settlement devices 13 included in the checkout system 10 can be freely selected, and the ratio of the number of commodity registration devices 11 to the number of settlement devices 13 can also be freely selected.

The commodity registration device 11 and the settlement device 13 are installed in a checkout corner or zone of a store such as a supermarket.

The operator of the commodity registration device 11 is an employee 21 of the store, who plays a role called a checker. The operator of the settlement device 13 is a shopper 22 who purchases commodities sold at the store. However, in some examples, operations of the commodity registration device 11 may be performed by the shopper 22. Furthermore, in some examples, a settlement device 13 may be operated by an employee 21 on behalf of the shopper 22. The employee 21 is an example of a clerk (store clerk).

The commodity registration device 11 is attached to a work table 31 in FIG. 1. The work table 31 has a rectangular top plate. A plurality of work tables 31 are arranged so that the longitudinal directions of the top plates are substantially parallel to each other, thereby forming a passage therebetween for the shopper 22.

The commodity registration device 11 has functions of purchase registration, generation of settlement information, settlement processing, and notification of settlement information to the settlement device 13. The purchase registration is a process of registering the commodity brought by the shopper 22 (who enters the passage) as a purchased commodity. The settlement processing is a process for the settlement (payment) for the purchased commodities. The settlement information is the information required for completion of the settlement processing. The commodity registration device 11 is an example of an information processing device.

If the settlement information is sent from the commodity registration device 11, the settlement device 13 performs settlement processing based on the settlement information.

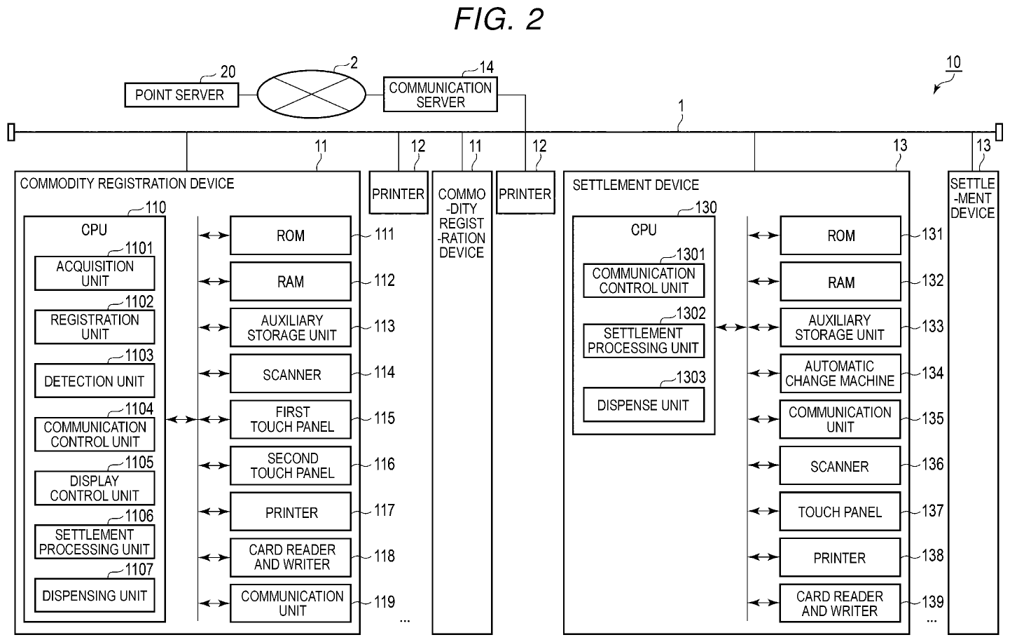

FIG. 2 is a block diagram illustrating the checkout system 10 according to the embodiment.

The checkout system 10 includes a commodity registration device 11, a printer 12, a settlement device 13, a communication server 14, and a point server 20. The checkout system 10 also includes a network 1. The network 1 connects the commodity registration device 11, the printer 12, the settlement device 13, and the communication server 14 to be able to communicate with each other. The network 1 is, for example, a local area network (LAN). The checkout system 10 further includes a network 2. The network 2 connects the communication server 14 and the point server 20. The network 2 is, for example, the Internet. The checkout system 10 may refer to a system including at least two out of the commodity registration device 11, the printer 12, the settlement device 13, the communication server 14, and the point server 20. The checkout system 10 is an example of an information processing system. The point server 20 is an example of an external server.

The commodity registration device 11 includes a central processing unit (CPU) 110, a read-only memory (ROM) 111, a random-access memory (RAM) 112, an auxiliary storage unit 113, a scanner 114, a first touch panel 115, a second touch panel 116, a printer 117, a card reader-writer 118, and a communication unit 119.

The CPU 110, the ROM 111, the RAM 112, and the auxiliary storage unit 113 are connected by a system transmission line to form a computer.

The CPU 110 corresponds to the central part of a computer. The CPU 110 controls each unit in order to realize various operations as the commodity registration device 11 based on the operating system, middleware, and application programs stored in the ROM 111 and the RAM 112.

The ROM 111 stores the operating system. The ROM 111 may also store the middleware and application programs. The ROM 111 may also store data that the CPU 110 refers to when performing various processes.

The RAM 112 stores data that the CPU 110 refers to when performing various processes. Furthermore, the RAM 112 is used as a so-called work area for storing data temporarily used by the CPU 110 for performing various processes.

The auxiliary storage unit 113 corresponds to the auxiliary storage part of the computer. The auxiliary storage unit 113 stores data used by the CPU 110 for performing various processes, or data generated by the processes of the CPU 110. As the auxiliary storage unit 113, for example, EEPROM® (electric erasable programmable read-only memory), a hard disk drive (HDD), a solid-state drive (SSD), or the like can be used.

The application program stored in the ROM 111 or the auxiliary storage unit 113 includes a control program for processing. The transfer of the commodity registration device 11 to an end user or the like is generally performed with the control program already stored in the ROM 111 or the auxiliary storage unit 113. However, the commodity registration device 11 may be transferred in a state in which the control program is not yet stored in the ROM 111 or the auxiliary storage unit 113, and the control program may be instead recorded on a removable recording medium and/or transferred via a network. In this case, for example, the control program is later written to the auxiliary storage unit 113 of the commodity registration device 11 in response to an operation by the user. As a removable recording medium, a magnetic disk, a magneto-optical disk, an optical disk, a semiconductor memory, or the like can be used.

A scanner 114 reads the information of the purchased commodity and obtains the commodity code of the purchased commodity. As the scanner 114, various well-known types can be used. The scanner 114 may be only one of the various well-known types or may be a plurality of types in combination or the like. That is, the scanner 114 may include a fixed two-dimensional code scanner and/or a hand-held (“handy”) two-dimensional code scanner. Further, the scanner 114 may incorporate or be a type of product scanner that identifies the purchased commodity from an image of the purchased commodity by using the image recognition technology. The scanner 114 is an example of a reading unit.

First touch panel 115 and second touch panel 116 each include a display device and a touch sensor. The display screen of the display device is any screen that can be used as a graphical user interface (GUI) screen. As the display device, for example, a well-known device such as a color LCD can be used. The touch sensor is arranged so as to overlap the display surface of the display device. The touch sensor detects the touch position of the operator on the display surface and sends the position information to the CPU 110. A well-known device can be used as a touch sensor. As shown in FIG. 1, the operation surface of the first touch panel 115 is directed toward a place where the employee 21 who operates the commodity registration device 11 should be located. As shown in FIG. 1, the operation surface of the second touch panel 116 is directed toward the place where the shopper 22 who purchases the commodity subject to the commodity registration performed by the commodity registration device 11 should be located. The first touch panel 115 is an example of a display unit. The first touch panel 115 is also an example of an input unit.

The printer 117 is, for example, a thermal printer or a dot impact printer and dispenses a receipt by printing various character strings, images, and the like on the receipt paper.

The card reader-writer 118 reads the data recorded on the card and writes the data to the above card. The card may include a settlement card such as a credit card, a debit card, an electronic money card, and a prepaid card, as well as various cards such as member's cards and loyalty cards that record or correlate with information related to the settlement processing. The card reader-writer 118 may be any of magnetic, contact, or non-contact devices and may incorporate a plurality of types of devices. The card reader-writer 118 is an example of a reading unit and a member code acquiring unit.

The communication unit 119 communicates via the LAN.

The CPU 110, the ROM 111, the RAM 112, the auxiliary storage unit 113, the scanner 114, the first touch panel 115, the printer 117, the card reader-writer 118, and the communication unit 119 transfer data via a system transmission line. As the system transmission line, various buses such as a system bus and various interface circuits connecting these buses and each unit can be used.

The hardware configuration of the commodity registration device 11 is not limited to the above configuration. As the hardware of the commodity registration device 11, for example, an existing-type of self-service POS terminal can be used. The commodity registration device 11 can also omit or substitute the above-mentioned components and add new components as appropriate.

The printer 12 is, for example, a thermal printer or a dot impact printer. The printer 12 communicates with the point server 20 via the network 1, the network 2, and the communication server 14 and dispenses a voucher by printing various character strings, images, and the like on the receipt paper.

The settlement device 13 includes a CPU 130, a ROM 131, a RAM 132, an auxiliary storage unit 133, an automatic change machine 134, a communication unit 135, a scanner 136, a touch panel 137, a printer 138, and a card reader-writer 139.

The CPU 130, the ROM 131, the RAM 132, and the auxiliary storage unit 133 are connected by a system transmission line to form a computer.

The CPU 130 controls each unit to realize various operations as the settlement device 13 based on the operating system, middleware, and application programs stored in the ROM 131 and the RAM 132.

The ROM 131 stores the operating system. The ROM 131 may store the middleware and application programs. The ROM 131 may also store data that the CPU 130 refers to when performing various processes.

The RAM 132 stores data that the CPU 130 refers to when performing various processes. Furthermore, the RAM 132 is used as a so-called work area for storing data temporarily used by the CPU 130 for performing various processes.

The auxiliary storage unit 133 corresponds to the auxiliary storage part of the computer. The auxiliary storage unit 133 stores data used by the CPU 130 to perform various processes or data generated by the processes in the CPU 130. As the auxiliary storage unit 133, for example, an EEPROM, an HDD, an SSD, or the like can be used.

The application program stored in the ROM 131 or the auxiliary storage unit 133 includes a control program. The transfer of the settlement device 13 is generally performed with the control program already stored in the ROM 131 or the auxiliary storage unit 133. However, the settlement device 13 may be transferred in a state in which the control program is not yet stored in the ROM 131 or the auxiliary storage unit 133, and the control program may be recorded on a removable recording medium or transferred via the network. In this case, the control program can be written to the auxiliary storage unit 133 of the settlement device 13 in response to an operation by the user.

The automatic change machine 134 collects coins and banknotes that are inserted. The automatic change machine 134 discharges coins and banknotes as change.

The communication unit 135 communicates via the LAN.

The scanner 136 reads the commodity information and obtains the commodity code of the commodity that has been scanned. As the scanner 136, various well-known types can be used. The scanner 136 may be compatible with only one of the various well-known types or may be compatible with a plurality of types. That is, the scanner 136 may be a fixed type and/or hand-held type two-dimensional code scanner. Further, the scanner 136 may be or incorporate a type of product scanner that identifies a commodity from an image of the commodity by using image recognition technology.

The touch panel 137 includes a display device and a touch sensor. The screen of the display device is any screen such as a GUI screen. As the display device, a well-known device such as a color LCD can be used. The touch sensor is arranged so as to overlap the display surface of the display device. The touch sensor detects the touch position of the operator on the display surface of the display device and sends the position information to the CPU 130. A well-known device can be used as a touch sensor.

The printer 138 is, for example, a thermal printer or a dot impact printer and dispenses a receipt by printing various character strings, images, and the like on the receipt paper.

The card reader-writer 139 reads the data recorded on the card and writes the data to the card. The card may include a settlement card such as a credit card, a debit card, an electronic money card, and a prepaid card, as well as various cards such as member's cards and loyalty cards that record information related to the settlement processing. The card reader-writer 139 may be any of magnetic, contact, or non-contact devices or may combine a plurality of types of devices.

The CPU 130, the ROM 131, the RAM 132, the auxiliary storage unit 133, the automatic change machine 134, the communication unit 135, the scanner 136, the touch panel 137, the printer 138, and the card reader-writer 139 transfer data via a system transmission line. As the system transmission line, various buses such as a system bus and various interface circuits connecting these buses and each unit can be used.

The hardware configuration of the settlement device 13 is not limited to the above configuration. As the hardware of the settlement device 13, for example, an existing-type self-service POS terminal can be used. It is possible to omit, change, or substitute the above-mentioned components and add new components as appropriate.

The communication server 14 supports data communication processing between the commodity registration device 11, the printer 12, the settlement device 13, and the point server 20.

The point server 20 stores member information for shoppers 22 who have previously registered as members (e.g. people who have joined a store loyalty program or the like). The member information includes a unique member ID assigned to each member in order to individually identify the member. The member ID correlates to the identification information, the member code, and the account. The member information includes the validity of membership registration, information regarding accumulated points, history of purchased commodities purchased by members, and the like. The member information corresponds to account information (the member's account information). The information regarding the points includes point information indicating points previously given to members. The point information includes the accumulated points up to the most recent commercial transaction (hereinafter, also referred to as “previous points”), the points acquired in this present commercial transaction (hereinafter, also referred to as “points for this time”), and the accumulated points reflecting this present commercial transaction (hereinafter, also referred to as “cumulative points after this time”). For example, a commercial transaction is a commodity sales transaction that includes settlement processing that has been completed. The commercial transaction thus includes completed settlement processing. The commercial transaction is sometimes called a transaction, a sales transaction, or a commodity sales transaction. Points are awarded according to the content of the commercial transaction (e.g., number of items purchased, types of items purchased, total amount paid for purchased items, date/time of the transaction, etc.).

Whenever the cumulative value of the previous points exceeds some default value, the point server 20 instructs to dispense a full-point ticket in this present commercial transaction. The full-point ticket is, for example, a voucher for certifying the right to receive a benefit based on the cumulative value of the previous points exceeding a default value. For example, the full-point ticket is a voucher for certifying the customer's right to receive a discount benefit of 500 yen when the cumulative value of the previous points exceeds the default value of 500 points. The full-point ticket is an example of a benefit ticket. The point server 20 stores information regarding the points accumulated and issued. The information regarding the points includes the full-point ticket status indicating that a full-point ticket was dispensed. The full-point ticket status is an example of information indicating that a full-point ticket was dispensed. The point server 20 outputs information regarding the points to the commodity registration device 11 or the settlement device 13 via the network 1, the network 2, and the communication server 14.

Next, each unit implemented by the CPU 110 in the commodity registration device 11 will be described. For example, the CPU 110 loads a program stored in advance in the ROM 111 or the auxiliary storage unit 113 into the RAM 112 and executes processing for performing the functions described for various units of the commodity registration device 11.

The CPU 110 implements an acquisition unit 1101, a registration unit 1102, a detection unit 1103, a communication control unit 1104, a display control unit 1105, a settlement processing unit 1106, and a dispensing unit 1107. It can be said that each unit implemented on the CPU 110 is implemented by a control unit or a controller including the CPU 110, the ROM 111, and the RAM 112.

The acquisition unit 1101 acquires data of various codes read by the scanner 114 or the card reader-writer 118. The acquisition unit 1101 acquires various information based on the acquired data. In one example, if the barcode of the purchased commodity is read by the scanner 114, the acquisition unit 1101 acquires the commodity code indicated by the barcode of the purchased commodity.

The commodity code is a unique ID assigned to each commodity in order to individually identify the commodity. The acquisition unit 1101 acquires the commodity sales information associated with the acquired commodity code. The commodity sales information is various information associated with the commodity code.

The commodity sales information includes the sales price and the like. The commodity sales information may be stored in advance in the auxiliary storage unit 113 or may be downloaded from a server to the commodity registration device 11 via the network 1. The commodity sales information may be updated as appropriate.

In another example, the acquisition unit 1101 acquires the member code if the member code recorded on a membership card is read by the card reader-writer 118. The member code may be read by the scanner 114 from a code symbol such as a barcode attached to the membership card.

The registration unit 1102 registers various information based on the data read by the scanner 114. In one example, if the barcode of the purchased commodity is read by the scanner 114, the registration unit 1102 registers the commodity information of the purchased commodity. For example, the commodity information includes the commodity code of the purchased commodity.

The detection unit 1103 detects a touch input to the screen by the operator on the first touch panel 115. The touch input is realized by touching the screen by the operator according to various messages displayed on the first touch panel 115. The screen on which the messages are displayed includes a button for specifying the operation. The operator specifies an operation by touching the displayed button. Touch input is an example of input. The message corresponds to a notification.

The communication control unit 1104 communicates various information with the settlement device 13 via the network 1. The communication control unit 1104 communicates various information with the point server 20 via the network 1, the network 2, and the communication server 14.

The display control unit 1105 outputs various notifications. The notification display method may be any method such as a pop-up display or the like.

The settlement processing unit 1106 executes the settlement processing. For example, the settlement processing unit 1106 executes the settlement processing according to the selection of a payment method made by the shopper 22.

The dispensing unit 1107 operates the printer 117 and dispenses a receipt showing the contents of the current commercial transaction.

The detection unit 1103, the communication control unit 1104, and the display control unit 1105 were described in this example as being implemented on the CPU 110 by executing a program, but the present disclosure is not limited thereto. The detection unit 1103 and the display control unit 1105 may be realized by the first touch panel 115. The communication control unit 1104 may be realized by the communication unit 119. The detection unit 1103 and the display control unit 1105 may be realized by the cooperation of devices such as the CPU 110 and the first touch panel 115 and execution of a program. The communication control unit 1104 may be realized by the cooperation of devices such as the CPU 110 and the communication unit 119 and execution of a program.

Next, each unit implemented on the CPU 130 in the settlement device 13 will be described. For example, the CPU 130 loads a program stored in advance in the ROM 131 or the auxiliary storage unit 133 into the RAM 132, and implements various units for performing the described functions of the settlement device 13.

The CPU 130 implements a communication control unit 1301, a settlement processing unit 1302, and a dispensing unit 1303. It can be said that each unit implemented on the CPU 130 is implemented on a control unit or a controller including the CPU 130, the ROM 131, and the RAM 132.

The communication control unit 1301 communicates various information with the commodity registration device 11 via the network 1. The communication control unit 1301 also communicates various information with the point server 20 via the network 1, the network 2, and the communication server 14.

The settlement processing unit 1302 executes the settlement processing. For example, the settlement processing unit 1302 executes the settlement processing according to the selection of the payment method made by the shopper 22.

The dispensing unit 1303 operates the printer 138 and dispenses a receipt showing the contents of the current commercial transaction.

The communication control unit 1301 was described as being implemented on the CPU 130 by executing a program, but the present disclosure is not limited thereto. The communication control unit 1301 may be realized by the communication unit 135. The communication control unit 1301 maybe realized by the cooperation of devices such as the CPU 130 and the communication unit 135 and execution of a program.

Next, an example of a screen displayed on the first touch panel 115 in the commodity registration device 11 will be described.

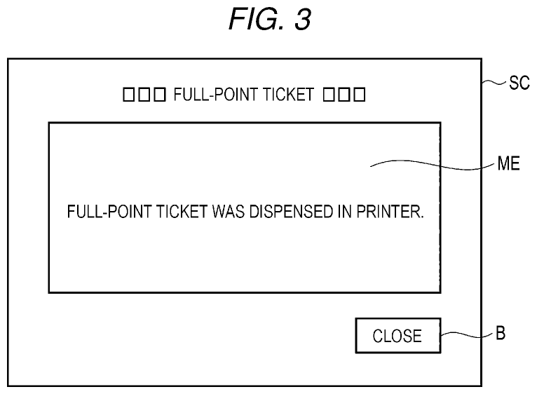

FIG. 3 is a diagram showing an example of a notification screen displayed on the first touch panel 115 of the commodity registration device 11 according to the embodiment.

As shown, a character message ME and a button B are displayed on a notification screen SC. The character message ME displays a message in a character string notifying the employee 21 that a full-point ticket was dispensed. The button B is operated for the employee 21 to declare that the notification screen SC is closed. The character message ME may represent a message as a moving image by using moving image data. Alternatively, the message may be output by voice by using voice data.

Next, the procedure of the commodity registration processing by the commodity registration device 11 will be described.

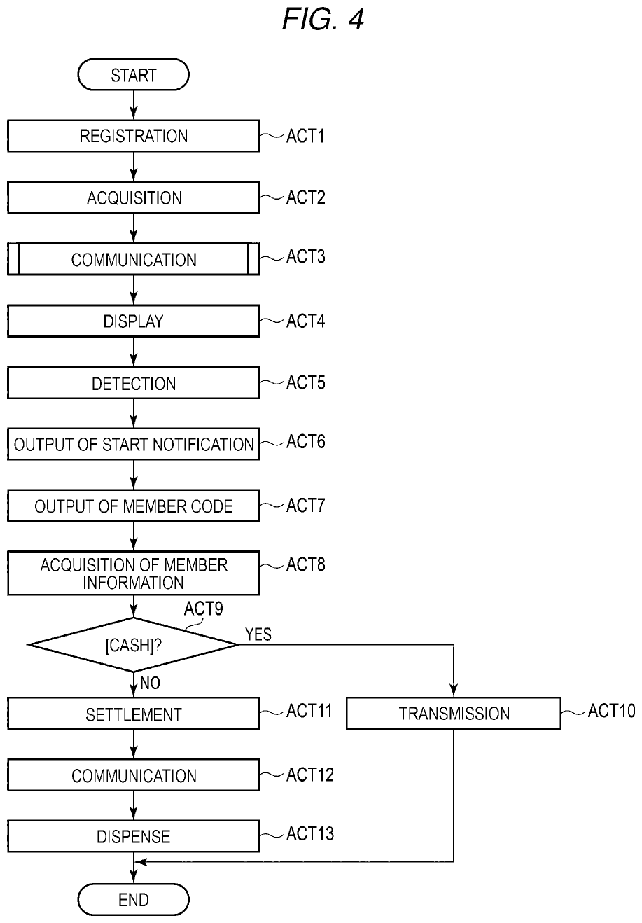

FIG. 4 is a flowchart illustrating the procedure of the commodity registration processing by the commodity registration device 11 according to the embodiment.

The processing procedure described below is only one example, and each process of the procedure may be changed in various ways. Furthermore, processes can be omitted, replaced, and/or added as appropriate according to the specific embodiment. References to an “operator” may be read as being either the employee 21 or the shopper 22.

First, when a barcode of a purchased commodity is read by the scanner 114, the commodity registration device 11 starts the commodity registration processing shown in FIG. 4 according to the control program stored in the ROM 111 or the auxiliary storage unit 113. The timing for starting the commodity registration processing is not limited thereto. For example, the commodity registration device 11 may automatically start the commodity registration processing when a certain period of time elapses after the processing for the shopper 22 immediately before is completed.

The registration unit 1102 registers various information based on the data read by the scanner 114 (ACT 1). In ACT 1, the acquisition unit 1101 acquires the commodity code of the commodity being purchased as read by the scanner 114 in response to the reading of the barcode of the commodity by the scanner 114. The registration unit 1102 then registers the commodity information for the purchased commodity based on the commodity code acquired by the acquisition unit 1101. For example, the registration unit 1102 generates a list of the commodity codes of purchased commodities (hereinafter referred to as a commodity list) and registers the commodity list in the auxiliary storage unit 113.

The acquisition unit 1101 acquires the member code (ACT 2). In ACT 2, the acquisition unit 1101 acquires the member code in response to the reading of the member code recorded on the membership card by the card reader-writer 118. The acquisition unit 1101 may acquire the member code in response to the reading of the member code from the two-dimensional code attached to the membership card by the scanner 114.

The communication control unit 1104 then communicates with the point server 20 after the acquisition of the member code by the acquisition unit 1101 and performs communication processing (ACT 3). In ACT 3, the communication control unit 1104 communicates with the point server 20 via the network 1, the network 2, and the communication server 14, and performs the communication processing. The communication control unit 1104 acquires information regarding the points associated with the member code from the point server 20. The information regarding the points includes previous points, points for this time, and cumulative points after this time. If the point server 20 determines that the previous points exceeded the default value and the point server 20 dispenses a full-point ticket, the information regarding the points then also includes the full-point ticket status.

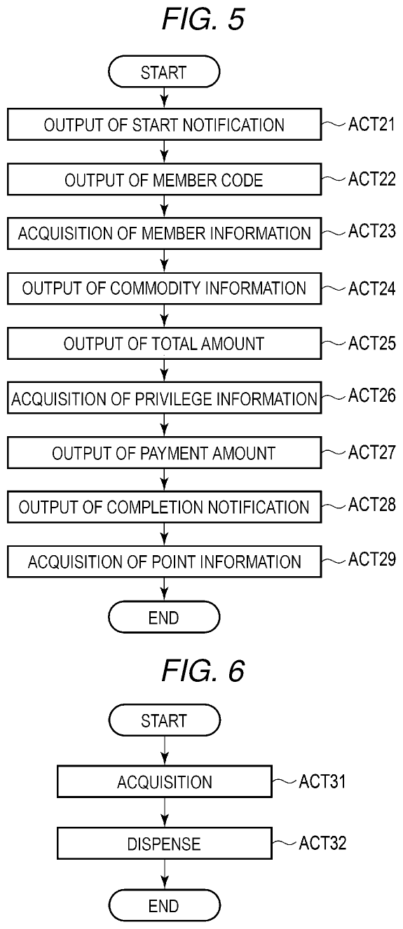

The communication processing at this time may include dummy transaction processing. Dummy transaction processing involves settlement processing based on information of a fictitious commodity (that is, a commodity not actually in the present sales transaction). The dummy transaction processing is a means to retrieve points information from the point server 20 without first performing an actual settlement process. In this example, the communication control unit 1104 acquires information regarding the points using a dummy transaction that is sent to the point server 20. Additional aspects of the communication processing in ACT 3 will be described later with reference to FIG. 5.

The display control unit 1105 causes the first touch panel 115 to display the information regarding the points acquired by the communication control unit 1104 in ACT 3 (ACT 4). In ACT 4, the display control unit 1105 causes the first touch panel 115 to display the previous points. The operator can also grasp whether or not a full-point ticket was dispensed this time by checking whether or not the previous points exceeded the default value. In addition to the previous points, the display control unit 1105 may display the points for this time and a part or all of the cumulative points after this time on the first touch panel 115. In one example, the cumulative points after this time are the total value of the previous points plus the points for this time. In another example, if a full-point ticket is dispensed, the cumulative points after this time is the value obtained by subtracting the points for the default value from the total value of the previous points plus the points for this time. If the information regarding the points includes the full-point ticket status, the display control unit 1105 displays the full-point ticket status on the first touch panel 115. For example, the display control unit 1105 causes the first touch panel 115 to display information indicating the dispense of the full-point ticket from the printer 12 based on the full-point ticket status, as in the notification screen SC (see FIG. 3). By checking the full-point ticket status, the operator can directly grasp that a full-point ticket was dispensed this time.

The display control unit 1105 does not necessarily have to display the previous points on the first touch panel 115. The display control unit 1105 does not necessarily have to display the points for this time and a part or all of the cumulative points after this time on the first touch panel 115.

The full-point ticket status was described as information indicating that the full-point ticket was dispensed, but the present disclosure is not limited thereto. The full-point ticket status may be information indicating that the full-point ticket was dispensed or that the full-point ticket was not dispensed. In this example, the full-point ticket status is an example of information indicating whether or not the full-point ticket is dispensed.

Regardless of whether the point server 20 dispenses a full-point ticket, the information regarding the points acquired from the point server 20 by the communication control unit 1104 can always include the full-point ticket status. The display control unit 1105 displays the full-point ticket status on the first touch panel 115.

According to this example, the commodity registration device 11 can notify the operator that the full-point ticket was dispensed before the settlement processing begins. Therefore, the commodity registration device 11 can help prevent the operator from forgetting the full-point ticket dispensed by the printer 12. Further, since the operator of the commodity registration device 11 can hand the full-point ticket to the shopper 22 before the settlement ends, it is possible to help prevent the shopper 22 from forgetting to take the full-point ticket. Furthermore, it is possible to reduce the time required to re-dispense a previously forgotten full-point ticket.

The detection unit 1103 detects a checkout instruction (ACT 5). In ACT 5, the detection unit 1103 detects the touch input by the operator of the checkout button on the first touch panel 115. The checkout instruction is an instruction for ending the registration processing and shifting from the registration processing to the settlement processing. The touch input of the checkout button is an example of a checkout instruction. For example, the detection unit 1103 detects that the checkout button is touched according to a signal from the first touch panel 115.

The communication control unit 1104 outputs a transaction start notification to the point server 20 in response to the detection of the checkout instruction by the detection unit 1103 (ACT 6). In ACT 6, the communication control unit 1104 transmits the transaction start notification to the point server 20 via the network 1, the network 2, and the communication server 14. The transaction start notification is a notification of the start of a commercial transaction.

The communication control unit 1104 outputs the member code acquired by the acquisition unit 1101 to the point server 20 (ACT 7). In ACT 7, the communication control unit 1104 transmits the member code to the point server 20 via the network 1, the network 2, and the communication server 14.

The communication control unit 1104 acquires the member information associated with the member code from the point server 20 (ACT 8). In ACT 8, the communication control unit 1104 acquires the member information from the point server 20 via the network 1, the network 2, and the communication server 14. For example, the member information includes information indicating that the member identified by the member code is registered.

The detection unit 1103 detects the designation of the settlement method (ACT 9). In ACT 9, the display control unit 1105 causes the first touch panel 115 to display a settlement screen. On the settlement screen, a “cash” button and an “other” button for specifying the settlement method are displayed. The “cash” button is a button for designating the shopper 22 will pay in cash. The “other” button is a button for designating payment other than cash, such as a credit card or a gift certificate will be used. If the detection unit 1103 detects that the “cash” button is touched by the signal from the first touch panel 115 (ACT 9: YES), the process transitions from ACT 9 to ACT 10. On the other hand, if the detection unit 1103 detects that the “other” button is touched by the signal from the first touch panel 115 (ACT 9: NO), the process transitions from ACT 9 to ACT 11.

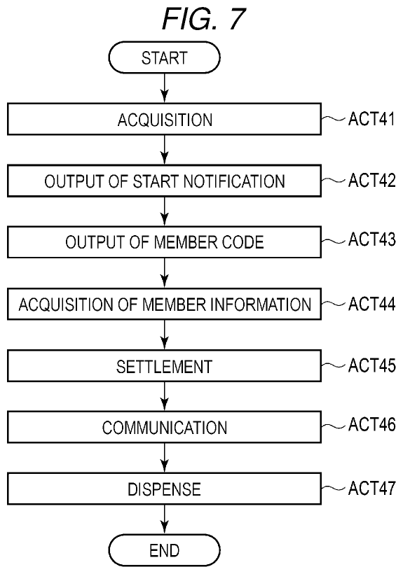

The communication control unit 1104 transmits the settlement information and the member code to the settlement device 13 in response to the detection by the detection unit 1103 that the “cash” button is touched (ACT 10). In ACT 10, the communication control unit 1104 transmits the settlement information based on the commodity list registered in the auxiliary storage unit 113 by the registration unit 1102 to the settlement device 13 via the network 1. The settlement information includes the commodity list. The settlement information may include the sales amount for the purchased commodity acquired by the acquisition unit 1101 based on the commodity list, the commodity prices, and the like. The communication control unit 1104 transmits the member code acquired by the acquisition unit 1101 in ACT 2 to the settlement device 13 via the network 1. The settlement device 13 acquires the settlement information and the member code and performs the communication processing shown in FIG. 7.

The settlement processing unit 1106 executes the settlement processing based on the settlement information in response to the detection by the detection unit 1103 that the “other” button is touched (ACT 11). In ACT 11, the settlement processing unit 1106 performs the settlement processing according to a payment method such as a credit card, a debit card, or a gift certificate. For example, in the case of credit card settlement, the credit card data is read by the card reader-writer 118, and the credit card is authenticated. Then, if the credit card is successfully authenticated, the settlement process is executed. In this settlement process, the settlement information including the total price, the payment method, the payment amount, and the like is stored in the auxiliary storage unit 113.

The communication control unit 1104 communicates with the point server 20 (ACT 12). In ACT 12, the communication control unit 1104 communicates various information related to the actual transaction with the point server 20 via the network 1, the network 2, and the communication server 14. In this context, reference to an actual transaction refers to a commercial transaction including just the items actually being purchased by the customer

First, the communication control unit 1104 outputs the commodity information to the point server 20 (first processing). In this first processing, the communication control unit 1104 outputs the commodity code included in the commodity list registered in the auxiliary storage unit 113 by the registration unit 1102 to the point server 20.

Next, the communication control unit 1104 outputs the total price to the point server 20 (second processing). In second processing, the communication control unit 1104 outputs the total price of the purchased commodities in the commodity list to the point server 20.

Next, the communication control unit 1104 acquires the benefit information based on the commodity information and the total price from the point server 20 (third processing). In third processing, the communication control unit 1104 acquires the benefit information based on the commodity codes included in the commodity list and the total price of the purchased commodities in the commodity list from the point server 20. For example, the benefit information is information indicating a discount rate given according to a specific purchased commodity or a predetermined purchase amount, the number of points given, and the like.

Next, the communication control unit 1104 outputs the payment amount to the point server 20 (fourth processing). In fourth processing, the communication control unit 1104 outputs the payment amount to the point server 20 based on the settlement completion information acquired in the settlement processing in ACT 11.

Next, the communication control unit 1104 outputs a transaction end notification to the point server 20 (fifth processing). The transaction end notification is a notification of the end of a commercial transaction.

Next, the communication control unit 1104 acquires information regarding the points from the point server 20 (sixth processing). In sixth processing, the communication control unit 1104 acquires the information regarding the points associated with the member code acquired in ACT 2 from the point server 20. In this case, the information regarding the points is the same information as the information regarding the points acquired in ACT 3. That is, the information regarding the points includes the previous points, the points for this time, and the cumulative points after this time. Since the full-point ticket status is acquired in the communication processing associated with ACT 3 (which includes dummy transaction processing to retrieve points information associated with the member code from the points server 20 before the start of settlement processing), the information regarding the points acquired in the sixth processing does not need to include the full-point ticket status.

The dispensing unit 1107 operates the printer 117 and dispenses a receipt showing the contents of the current (actual) commercial transaction (ACT 13). The receipt contains, for example, information regarding the points.

Next, the procedure of the communication processing (ACT 3) by the commodity registration device 11 will be described.

FIG. 5 is a flowchart illustrating a procedure of the communication processing by the commodity registration device 11 according to an embodiment.

The processing procedure described below is only one example, and each process may be changed in various ways. Furthermore, processes can be omitted, replaced, and/or added as appropriate according to the specific embodiment.

First, the communication control unit 1104 communicates with the point server 20 based on the acquisition of the member code by the acquisition unit 1101 and starts the communication processing shown in FIG. 5 according to the control program stored in the ROM 111 or the auxiliary storage unit 113. For example, the communication control unit 1104 communicates with the point server 20 via the network 1, the network 2, and the communication server 14, and starts the communication processing. The communication processing here utilizes or is based on a dummy transaction. The dummy transaction is executed before the settlement of the actual commodities being purchased.

The communication control unit 1104 outputs a transaction start notification to the point server 20 in response to the acquisition of the member code by the acquisition unit 1101 (ACT 21). In ACT 21, the communication control unit 1104 transmits a transaction start notification to the point server 20. ACT 21 is the same process as ACT 6 of FIG. 4.

The communication control unit 1104 outputs the member code acquired by the acquisition unit 1101 to the point server 20 (ACT 22). In ACT 22, the communication control unit 1104 transmits the member code to the point server 20. ACT 22 is the same process as ACT 7 of FIG. 4.

The communication control unit 1104 acquires the member information associated with the member code from the point server (ACT 23). In ACT 23, the communication control unit 1104 acquires member information including information indicating that the member identified by the member code is registered from the point server 20. ACT 23 is the same process as ACT 8 of FIG. 4.

The communication control unit 1104 outputs the commodity information to the point server 20 (ACT 24). In ACT 24, the communication control unit 1104 outputs a dummy commodity code to the point server 20. The dummy commodity code is a code indicating a fictitious commodity different from the purchased commodity of the shopper 22. ACT 24 is otherwise the same process as the first processing in ACT 12 of FIG. 4.

The communication control unit 1104 outputs the total price to the point server 20 (ACT 25). In ACT 25, the communication control unit 1104 outputs the information indicating the total price of the dummy commodity to the point server 20. The total price of the dummy may be preset as “0 yen” or may be the amount associated with the dummy commodity code (“0 yen”). ACT 25 is otherwise the same process as the second processing in ACT 12 of FIG. 4.

The communication control unit 1104 acquires the benefit information based on the commodity information and the total price from the point server 20 (ACT 26). In ACT 26, the communication control unit 1104 acquires the benefit information for the dummy based on the dummy commodity code and the total price of the dummy from the point server 20. The benefit information of the dummy may be preset as information indicating “no benefit”, or may be benefit information associated with the dummy commodity code and the total price of the dummy (“no benefit”). ACT 26 is otherwise the same process as the third processing in ACT 12 of FIG. 4.

The communication control unit 1104 outputs the payment amount to the point server 20 (ACT 27). In ACT 27, the communication control unit 1104 outputs the information indicating the payment amount of the dummy to the point server 20. The payment amount of the dummy may be preset as “0 yen”, or may be an amount associated with the dummy commodity code or the total price of the dummy (“0 yen”). ACT 27 is otherwise the same process as the fourth processing in ACT 12 of FIG. 4.

The communication control unit 1104 outputs a transaction end notification to the point server 20 (ACT 28). ACT 28 is the same process as the fifth processing in ACT 12 of FIG. 4.

The communication control unit 1104 acquires the information regarding the points associated with the member code from the point server 20 (ACT 29). In ACT 29, the communication control unit 1104 acquires the information regarding the points associated with the member code acquired in ACT 2 based on a dummy transaction communicated to the point server 20. In a typical example, the communication control unit 1104 acquires the information regarding the points based on the output of the dummy commodity code, the information indicating the total price of the dummy, and the information indicating the payment amount of the dummy to the point server 20. The information regarding the points includes the previous points, the points for this time (though the dummy transaction points will generally be zero), and the cumulative points after this time (though the cumulative points will generally be unchanged by the dummy transaction, excepting if a full-point ticket is issued as a result of the dummy transaction). If the point server 20 dispenses a full-point ticket, the information regarding the points includes the full-point ticket status. ACT 29 is the same process as the sixth processing in ACT 12 of FIG. 4.

The communication control unit 1104 outputs information for the dummy transaction as the current commercial transaction in accordance with the standard specification that the point server 20 outputs the information regarding the points. That is, the points server 20 normally outputs points information only after an actual commercial transaction is completed, but the dummy transaction permits the points information to be acquired prior to completion of the actual commercial transaction. The communication control unit 1104 outputs the dummy commodity code, the information indicating the total price of the dummy, and the information indicating the payment amount of the dummy to the point server 20, but the present disclosure is not limited thereto. The information regarding the dummy transaction output by the communication control unit 1104 to the point server 20 can be changed as necessary according to the specifications of the point server 20. The communication control unit 1104 may output just some of the dummy commodity code, the information indicating the total price of the dummy, and the information indicating the payment amount of the dummy to the point server 20.

According to this example, by replacing the processing of an actual transaction between the commodity registration device 11 and the point server 20 with the dummy transaction processing, the commodity registration device 11 can acquire the information regarding the points before the settlement processing for the actual transaction has been completed. Therefore, it is not necessary to change the specifications of the point server 20 to provide points information on any prompting other than the standard settlement completion notification or the like. In addition, it is highly versatile in relation to the point server 20.

Next, the procedure of the dispensing processing by the printer 12 will be described.

FIG. 6 is a flowchart illustrating the procedure of the dispensing processing by the printer 12 according to an embodiment.

The processing procedure described below is only one example, and each process may be changed in various ways. Furthermore, processes can be omitted, replaced, and/or added as appropriate according to the specific embodiment.

First, the printer 12 communicates with the point server 20 via the network 1, the network 2, and the communication server 14, and starts the dispensing processing shown in FIG. 6 according to the control program stored in the printer 12.

The printer 12 acquires an instruction to dispense a full-point ticket from the point server 20 (ACT 31). In ACT 31, for example, the point server 20 outputs a full-point ticket dispense instruction to the printer 12 if it is determined that the previous points exceeded the default value. The point server 20 outputs a full-point ticket dispense instruction to the printer 12 installed near the commodity registration device 11 to which information regarding the points is output.

The printer 12 dispenses a full-point ticket in response to the acquisition of the full-point ticket dispense instruction from the point server 20 (ACT 32). In ACT 32, the printer 12 dispenses a full-point ticket before the settlement processing.

According to this example, the commodity registration device can dispense a full-point ticket before the settlement processing of the purchased commodity is completed (or even started). Therefore, it is possible to reduce the risk of forgetting to take the full-point ticket as compared with the case where the settlement device 13 dispenses the full-point ticket only after the settlement processing is finished.

Although an example in which the printer 12 dispenses a full-point ticket was described, the present disclosure is not limited thereto. The point server 20 may instead output a full-point ticket dispense instruction to the commodity registration device 11 which is the output destination of the information regarding the points. In this case, the dispensing unit 1107 of the commodity registration device 11 operates the printer 117 to dispense a full-point ticket.

Next, the procedure of the communication processing by the settlement device 13 will be described.

FIG. 7 is a flowchart illustrating a procedure of the communication processing by the settlement device 13 according to the embodiment.

The processing procedure described below is only one example, and each process may be changed in various ways. Furthermore, processes can be omitted, replaced, and/or added as appropriate according to the specific embodiment.

First, the settlement device 13 communicates with the commodity registration device 11 via the network 1 in ACT 10 and starts the communication processing shown in FIG. 7 according to the control program stored in the ROM 131 or the auxiliary storage unit 133. The settlement device 13 communicates with the commodity registration device 11 and the point server 20 via the network 1, the network 2, and the communication server 14.

The communication control unit 1301 acquires the settlement information and the member code from the commodity registration device 11 (ACT 41). In ACT 41, the communication control unit 1301 receives the settlement information and the member code from the commodity registration device 11 via the network 1.

The communication control unit 1301 outputs a transaction start notification to the point server 20 (ACT 42). In ACT 42, the communication control unit 1301 transmits a transaction start notification to the point server 20 based on the acquisition of the settlement information. ACT 42 is the same process as ACT 6 of FIG. 4, except that the content of the information processed is different.

The communication control unit 1301 outputs the member code to the point server 20 (ACT 43). In ACT 43, the communication control unit 1301 transmits the member code acquired from the commodity registration device 11 to the point server 20. ACT 43 is the same process as ACT 7 of FIG. 4, excepting that the content of the information processed is different.

The communication control unit 1301 acquires the member information associated with the member code from the point server (ACT 44). In ACT 44, the communication control unit 1301 acquires the member information from the point server 20 including the information indicating that the member identified by the member code was registered. ACT 44 is the same process as ACT 8 of FIG. 4, except that the content of the information processed is different.

The settlement processing unit 1302 executes the settlement processing (ACT 45). In ACT 45, the settlement processing unit 1302 performs the settlement processing by cash payment. The settlement processing unit 1302 calculates the deposited amount and executes the settlement processing if the total price is exceeded. If the change amount is calculated in this settlement processing, the settlement processing unit 1302 operates the automatic change machine 134 to pay out the change. The payout function is realized by the cooperation between the settlement processing unit 1302 and the automatic change machine 134. In this settlement processing, the settlement completion information including the total price, the payment method, the payment amount, and the like is stored in the auxiliary storage unit 133.

The communication control unit 1301 communicates with the point server 20 (ACT 46). In ACT 46, the communication control unit 1301 communicates various information related to the actual transaction with the point server 20 via the network 1, the network 2, and the communication server 14. The following first-type to sixth-type processes are substantially the same processes as the above-described first to sixth processes, except that the content of the information being processed is different.

First, the communication control unit 1301 outputs the commodity information to the point server 20 (first-type processing). In this first-type processing, the communication control unit 1301 outputs the commodity code included in the commodity list to the point server 20.

Next, the communication control unit 1301 outputs the total price to the point server 20 (second-type processing). In this second-type processing, the communication control unit 1301 outputs the total price of the purchased commodities in the commodity list to the point server 20.

Next, the communication control unit 1301 acquires the benefit information based on the commodity information and the total price from the point server 20 (third-type processing). In third-type processing, the communication control unit 1301 acquires the benefit information based on the commodity code included in the commodity list and the total price of the purchased commodities in the commodity list from the point server 20.

Next, the communication control unit 1301 outputs the payment amount to the point server 20 (fourth-type processing). In this fourth-type processing the communication control unit 1301 outputs the payment amount to the point server 20 based on the settlement completion information acquired in the settlement processing in ACT 45.

Next, the communication control unit 1301 outputs a transaction end notification to the point server 20 (fifth-type processing).

Next, the communication control unit 1301 acquires the information regarding the points from the point server 20 (sixth-type processing). In this sixth-type processing, the communication control unit 1301 acquires the information regarding the points associated with the member code from the point server 20. In this case, the information regarding the points is the same information as the information regarding the points acquired in ACT 3. That is, the information regarding the points includes the previous points, the points for this time, and the cumulative points after this time. Since the full-point ticket status is acquired in ACT 3, the information regarding the points acquired in sixth-type processing does not include the full-point ticket status.

The dispensing unit 1303 operates the printer 138 and dispenses a receipt showing the contents of the current commercial transaction (ACT 47). The receipt contains, for example, point information.

According to this example, since it is not necessary to perform the full-point ticket dispense processing in the settlement device 13, the processing processes in the settlement device 13 can be reduced.

In an embodiment, the settlement device 13 was described as performing the settlement processing when cash payment is the settlement method, but settlement processing using an electronic money card or a prepaid card is also possible.

In an embodiment, the checkout system including the semi-self-service type settlement device 13 is illustrated, but at least a part of the functions of the settlement device 13 may be realized in a POS terminal at which the clerk performs the operations from the registration to the settlement of the purchased commodity. Furthermore, at least a part of the functions of the commodity registration device 11 or the settlement device 13 may be realized in a so-called self-service type settlement device at which the customer performs the processing from the registration to the settlement of the purchased commodity. Furthermore, at least a part of the described functions of the present embodiment may be realized in a so-called cart POS terminal (e.g., a cart mounted POS terminal, a cart-based POS terminal, or the like) in which a commodity scanner and a dedicated terminal operated by a customer are attached to a cart. Similarly, at least a part of the described functions of the present embodiment may be realized in a so-called smartphone POS terminal on which the commodity registration is performed on a terminal device such as a tablet computer or a smartphone.

The information processing device may be realized as one device as illustrated by using the commodity registration device 11 or may be realized by a system in which the functions are distributed among a plurality of devices and/or processors.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A voucher dispensing device, comprising:
a communication interface connectable to a member points server;
a member code acquiring unit configured to receive an input of a member code; and
a processor configured to:
acquire information regarding points associated with the member code from the member points server by sending a dummy transaction notification to the member points server via the communication interface, and
control a display unit to display the acquired information regarding the points.

2. The voucher dispensing device according to claim 1, further comprising:
a printer, wherein
the processor is further configured to control the printer to print a voucher based on the acquired information regarding the points.

3. The voucher dispensing device according to claim 1, wherein the dummy transaction notification includes a dummy commodity code, a dummy commodity price, and a dummy transaction total.

4. The voucher dispensing device according to claim 1, wherein the dummy transaction notification has the same format as a standard transaction notification and only the content of the dummy transaction notification differs from the standard transaction notification.

5. The voucher dispensing device according to claim 1, wherein the information regarding the points includes an indication of whether or not a voucher has been issued.

6. The voucher dispensing device according to claim 1, further comprising:
a commodity scanner for acquiring commodity codes for commodities being purchased in a sales transaction, wherein
the processor is further configured to:
generate a commodity list for the sales transaction based on the commodity codes acquired by the commodity scanner.

7. The voucher dispensing device according to claim 6, wherein the processor is further configured to:
send a transaction notification to the member points server via the communication interface when generation of the commodity list for the sales transaction is ended.

8. The voucher dispensing device according to claim 7, wherein the dummy transaction notification is sent to the member points server before the transaction notification is sent to the member points server.

9. The voucher dispensing device according to claim 8, further comprising:
a printer, wherein
the processor is further configured to control the printer to print a voucher based on the information regarding the points acquired in response to the dummy transaction notification.

10. The voucher dispensing device according to claim 7, wherein the dummy transaction notification is sent to the member points server immediately after the member code is received by the member code acquiring unit.

11. The voucher dispensing device according to claim 1, wherein the dummy transaction notification is sent to the member points server immediately after the member code is received by the member code acquiring unit.

12. A voucher dispensing system, comprising:
a member points server in which member codes are stored in association with points information;
a voucher dispensing device in a retail store and including:
a communication interface connected to the member points server by a network;
a member code acquiring unit configured to receive an input of a member code of a customer at the retail store; and
a processor configured to:
acquire points information associated with the member code of the customer from the member points server by sending a dummy transaction notification to the member points server via the communication interface, and
control a display unit to display the acquired points information.

13. The voucher dispensing system according to claim 12, further comprising:
a printer, wherein
the processor is further configured to control the printer to print a voucher based on the acquired points information.

14. The voucher dispensing system according to claim 12, wherein the dummy transaction notification has the same format as a standard transaction notification and only the content of the dummy transaction notification differs from the standard transaction notification.

15. The voucher dispensing system according to claim 12, the voucher dispensing device further including:
a commodity scanner for acquiring commodity codes for commodities being purchased in a sales transaction, wherein
the processor is further configured to:
generate a commodity list for the sales transaction based on the commodity codes acquired by the commodity scanner.

16. The voucher dispensing system according to claim 15, wherein the processor is further configured to:
send a transaction notification to the member points server via the communication interface when generation of the commodity list for the sales transaction is ended.

17. The voucher dispensing system according to claim 16, wherein the dummy transaction notification is sent to the member points server before the transaction notification is sent to the member points server.

18. A voucher dispensing method, comprising:
acquiring information regarding points associated with a member code from a member points server by sending a dummy transaction notification to the member points server via a communication interface; and
controlling a display unit to display the acquired information regarding the points.

19. The voucher dispensing method according to claim 18, further comprising:
generating a commodity list for a sales transaction based on commodity codes acquired by a commodity scanner; and
sending a transaction notification to the member points server via the communication interface when generation of the commodity list for the sales transaction is ended, wherein
the dummy transaction notification is sent to the member points server before the transaction notification is sent to the member points server, and
the dummy transaction notification has the same format as the transaction notification and only the content of the dummy transaction notification differs from the transaction notification.

20. The voucher dispensing method according to claim 19, further comprising:
printing a voucher based on the information regarding points acquired from the points server in response to the dummy transaction notification, wherein
the printing of the voucher is performed before the sending of the transaction notification.
